(19) United States
(12) Patent Application Publication
(10) Pub. No.: US 2012/0128031 A1
(43) Pub. Date: May 24, 2012

(54) Electronic Clinical Thermometer

(75) Inventor: Chu-Yih Yu, Taipei Hsien (TW)

(73) Assignee: MESURE TECHNOLOGY CO., LTD., San Chung City (TW)

(21) Appl. No.: 13/013,005

(22) Filed: Jan. 25, 2011

(30) Foreign Application Priority Data
Nov. 19, 2010 (TW) 099222647

(51) Int. Cl. G01K 7/00

(52) U.S. Cl. 374/165; 374/E07.001

(57) ABSTRACT

A thermometer is constituted by a body member with a display portion and a tip member secured to the body member. The tip member has a hollow cavity and a thermal contact surface surrounding the hollow cavity. A thermal sensor is mounted on the inside of the tip member, adapted for sensing the thermal contact surface and producing a temperature signal. Lead wires are coupled to the thermal sensor for transmission of the temperature signal to the display portion. A hollow heat conductive structure is inserted into the hollow cavity of the tip member, including a film with a heat conductive surface which is directly contacted and against the inside of the thermal contact surface. The lead wires are integrated on the heat conductive surface of the film such that the lead wires and the heat conductive surface are coplanar to form a single piece.

### BACKGROUND OF THE INVENTION

1. Field of the Invention

The invention relates to the field of thermometers, and more particularly to the field of thermometers with a hollow heat-conductive structure.

2. Description of the Related Art

Electronic thermometers generally offer a great number of advantages over conventional glass and mercury thermometers for use in the health care field. Among the advantages of electronic thermometers are the elimination of sterilization procedures for glass thermometers, made possible by the use of disposable covers; elimination of the possibility of broken glass if a thermometer is dropped; a digital temperature display to eliminate temperature reading errors; and with proper circuit design and calibration, higher accuracy and resolution is possible with accurate measurement and display of tenths of a degree Fahrenheit being easily attainable.

However, the major concern with regard to the electronic thermometers lays on their slow time response. This problem is incurred mainly because a thermometer probe represents a certain amount of mass and heat capacity, and when inserted from room temperature into a body cavity it cannot change temperature instantaneously, but instead approaches its final temperature more or less exponentially. It often requires over two minutes lag time before a final stabilized temperature is measured.

### SUMMARY OF THE INVENTION

An exemplary embodiment of the present invention overcomes the above-described problems by providing a thermometer constituted by a body member with a display portion and a tip member secured to the body member. The tip member has a hollow cavity and a thermal contact surface surrounding the hollow cavity. A thermal sensor is mounted on the inside of the tip member, adapted for sensing the thermal contact surface and producing a temperature signal. Lead wires are coupled to the thermal sensor for transmission of the temperature signal to the display portion. A hollow heat conductive structure is inserted into the hollow cavity of the tip member, including a film with a heat conductive surface which is directly contacted and against the inside of the thermal contact surface. The lead wires are integrated on the heat conductive surface of the film such that the lead wires and the heat conductive surface are coplanar to form a single piece.

### DESCRIPTION OF THE DRAWINGS

The present invention will be described by way of exemplary embodiments, but not limitations, illustrated in the accompanying drawings in which like references denote similar elements, and in which:

FIG. 1 is a schematic view of a thermometer with a hollow heat-conductive structure according to an exemplary embodiment of the invention;

FIGS. 2A-2D are schematic views of a process for making a hollow heat-conductive structure according to an exemplary embodiment of the invention.

FIG. 3 is a schematic view of a hollow heat-conductive structure according to an exemplary embodiment of the invention

### DETAILED DESCRIPTION OF THE INVENTION

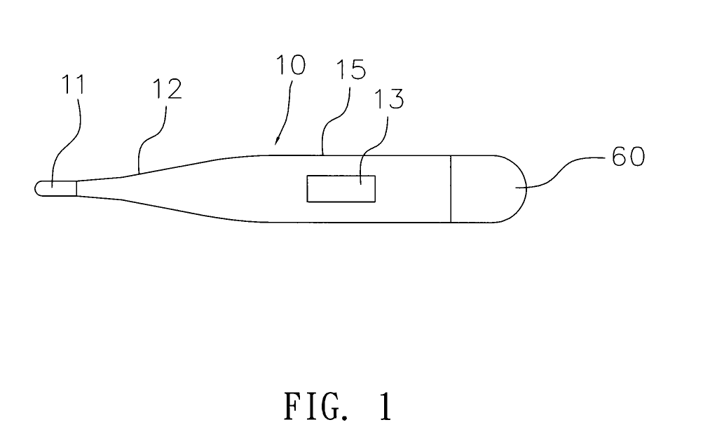

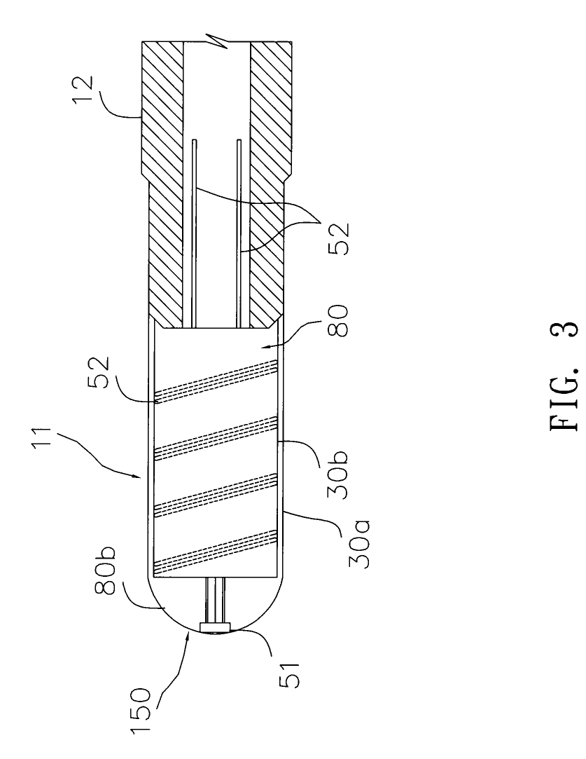

Referring to FIGS. 1 and 3, an embodiment of a thermometer is illustrated. The thermometer is made up of a body member 10 and a tip member 11. Typically, a cover 60 is secured to body member 10 after components of the thermometer have been assembled. Body member 10 includes a probe portion 12 and a display portion 15. Tip member 11 is secured to probe portion 12 of body member 10. Preferably, it contains a thermal contact surface surrounding a hollow cavity. In one embodiment, hollow tip member 11 is preferably made of metal with good thermal conductivity, such as stainless steel.

A thermal sensor 51 is placed at a front end 150 of tip member 11 and mounted on the inside of the thermal contact surface. Thermal sensor 51 senses the temperature of the thermal contact surface and produces a temperature signal. There are a set of lead wires 52 coupled to thermal sensor 51 for transmission of the temperature signal.

As shown in FIG. 1, a digital display 13 is disposed in display portion 15 and connected to the lead wires 52 to receive the temperature signal for display of a corresponding temperature reading.

In one example, tip member 11, including a cylindrical region, is made in the form of a tubular shape and closed at a domed, hemispherical or hemiellipsoid shaped end. The contact surface is brought in contact with flesh of a patient so that heat can be transferred from the patient's flesh to tip member 11. In one embodiment, thermal sensor 51 is thermistor. Thermistor 51 is adhered on the inside of the thermal contact surface with heat conductive glue. The glue is an insulating material with good thermal conductivity, e.g., epoxy resin. Moreover, lead wires 52 are made up of a pair of electrical lead wires; they are used to connect the thermal sensor 51 to a processor of display portion 15 for determining a corresponding temperature to display.

Referring to FIG. 3, a feature of the embodiment is that a hollow heat conductive structure 80 is substantially dimensioned and configured to permit insertion into hollow cavity 80b of tip member 11. Hollow heat conductive structure 80 comprises a film with a heat conductive surface 30b and lead wires 52 being integrated on heat conductive surface 30b of the film such that lead wires 52 and heat conductive surface 30b are coplanar to form a single piece (i.e. monolithic) which is directly contacted and against the inside of thermal contact surface 30a. In one example, heat conductive surface 30b of the film, preferably a hollow cylindrical surface, is in size and shape to substantially fit the size and shape of at least a portion of hollow cavity 80b of tip member 11. Specifically, a main portion of hollow cavity 80b, such as an entire cylindrical region of tip member 11, is surrounded by heat conductive surface 30b of the film.

To enhance structural strength and conductive effect, optionally, lead wires 52 are integrated on heat conductive surface 30b of the film in a spiral form. Surrounded by thermal contact surface 30a, heat conductive surface 30b of the film serves as a heater so lead wires 52 come to the equilibrium temperature immediately, since lead wires 52 and heat conductive surface 30b are coplanar to form a single piece which is directly contacted and against the inside of thermal contact surface 30a. This effectively shortens the measurement time further. In this way, thermistor 51 and lead wires 52 can reach thermal equilibrium very quickly.

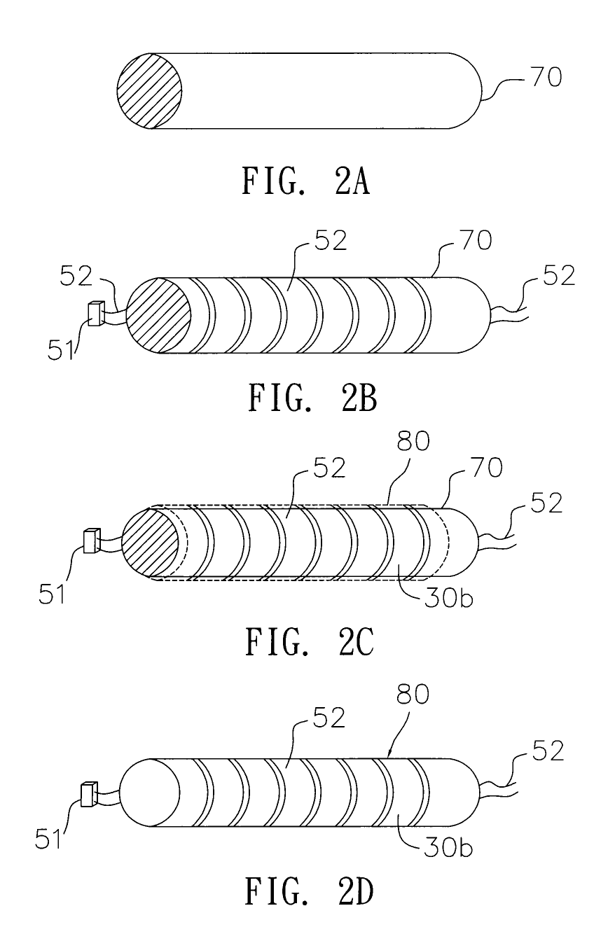

Referring to FIGS. 2A-2D, a process for making a hollow heat-conductive structure of an exemplary embodiment is illustrated. Initially, as shown in FIG. 2A, a support member 70 with a non-stick outer surface is first provided. For example, the support member may comprise a solid or hollow cylindrical structure which can be coated with a non-stick layer, such as polytetrafluorethene material.

Next, as shown in FIG. 2B, lead wires 52 is wrapped around the non-stick outer surface of support member 70, preferably in a spiral form. In one example, thermal sensor 51 is arranged on the front side of support member 70 to electrically connect lead wires 52.

As shown for instance in FIG. 2C, a thermally conductive adhesive material is then coated on the non-stick outer surface of support member 70. After curing, the film made of the thermally conductive adhesive material is formed to cover the non-stick outer surface of support member 70. Specifically, lead wires 52 are integrated on heat conductive surface 30b of the film such that lead wires 52 and heat conductive surface 30b are coplanar to form a single piece (i.e. monolithic).

Turning to FIG. 2D, hollow heat conductive structure 80 is easily took out from support member 70 because of its non-stick outer surface. In this case, hollow heat conductive structure 80 can keep its shape and structural stability during this removal process.

Referring to FIG. 3, hollow heat conductive structure 80 is then inserted into hollow cavity 80b of tip member 11. Thermal sensor 51 is placed at a front end 150 of tip member 11 and mounted on the inside of the thermal contact surface. Cover 60 is secured to body member 10 including probe portion 12 and display portion 15, after components of the thermometer have been assembled. In one example, the size of hollow heat conductive structure 80 is designed to a little larger than that of hollow cavity 80b of tip member 11 before it is inserted into hollow cavity 80b. Thus, hollow heat conductive structure 80 can apply an expansion force toward the inner wall of thermal contact surface 30a, such that a tight interface between hollow heat conductive structure 80 and thermal contact surface 30a is provided. This effectively shortens the measurement time further since heat from patient's flesh is easily and uniformly transferred to the film and lead wires 52 of hollow heat conductive structure 80 from thermal contact surface 30a. In this way, thermistor 51 and lead wires 52 can reach thermal equilibrium quickly.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A thermometer comprising:
a body member having a display portion;
a tip member secured to the body member, having a hollow cavity and a thermal contact surface surrounding the hollow cavity;
a thermal sensor mounted on the inside of the tip member, adapted for sensing the thermal contact surface and producing a temperature signal;
lead wires, coupled to the thermal sensor for transmission of the temperature signal to the display portion for display of a corresponding temperature reading; and
a hollow heat conductive structure inserted into the hollow cavity of the tip member, comprising a film with a heat conductive surface which is directly contacted and against the inside of the thermal contact surface, wherein the lead wires are integrated on the heat conductive surface of the film such that the lead wires and the heat conductive surface are coplanar to form a single piece.

2. The thermometer as recited in claim 1 wherein the hollow heat conductive structure is substantially dimensioned and configured to permit insertion into the hollow cavity of the tip member.

3. The thermometer as recited in claim 1 wherein the heat conductive surface of the film comprises a hollow cylindrical surface which is in size and shape to substantially fit the size and shape of at least a portion of the hollow cavity of the tip member.

4. The thermometer as recited in claim 1 wherein the lead wires are integrated on the heat conductive surface of the film in a spiral form.

5. The thermometer as recited in claim 1 wherein the size of the hollow heat conductive structure is designed to larger than that of the hollow cavity of the tip member before it is inserted into the hollow cavity such that the hollow heat conductive structure applies a force toward the inner wall of the thermal contact surface.

6. The thermometer as recited in claim 1 wherein the tip member is made of metal.

7. A thermometer comprising:
a body member;
a tip member secured to the body member, having a hollow cavity and a thermal contact surface surrounding the hollow cavity;
a thermal sensor mounted on the inside of the tip member, adapted for sensing the thermal contact surface;
lead wires, coupled to the thermal sensor; and
a hollow heat conductive structure inserted into the hollow cavity of the tip member, comprising a film with a heat conductive surface which is directly contacted and against the inside of the thermal contact surface, wherein the lead wires are integrated on the heat conductive surface of the film such that the lead wires and the heat conductive surface are coplanar to form a single piece.

8. The thermometer as recited in claim 7 wherein at least a portion of the hollow cavity of the tip member is surrounded by the heat conductive surface of the film.

9. The thermometer as recited in claim 8 wherein the at least a portion of the hollow cavity of the tip member comprises an entire cylindrical region.

10. The thermometer as recited in claim 7 wherein the lead wires are integrated on the heat conductive surface of the film in a spiral form.
